(19) United States
(12) Patent Application Publication
(10) Pub. No.: US 2008/0228445 A1
(43) Pub. Date: Sep. 18, 2008

(54) Instrument display with multiple-range visual depictions

(76) Inventor: Bruce Hamilton, Menlo Park, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/724,728

(22) Filed: Mar. 16, 2007

(51) Int. Cl. G06F 15/00

(52) U.S. Cl. 702/189

(57) ABSTRACT

An instrument display that provides increased utility and flexibility by employing multiple range visual depictions. An instrument according to the present teachings includes an instrument display for providing a visual depiction of a set of physical phenomena wherein the visual depiction includes a trace for each physical phenomenon superimposed on a set of axes that provide multiple ranges.

### BACKGROUND

An instrument may include an instrument display for providing a visual depiction of how a physical phenomenon behaves with respect to a quantity of interest. For example, an oscilloscope may have a display for providing a visual depiction of how a magnitude of an electrical signal behaves with respect to time.

A visual depiction of a physical phenomenon on an instrument display may include a trace superimposed on an axis that represents a range of a quantity of interest. For example, a visual depiction of an electrical signal on an oscilloscope display may include a trace that represents voltage values superimposed onto an x-axis that represents a range of time.

A visual depiction of a physical phenomenon generated by a prior instrument may include only a single range. For example, a display for a prior oscilloscope may include one horizontal axis that represents a range of time onto which one or more traces may be superimposed. Unfortunately, prior instruments that provide a single range may be relatively limited in their ability to depict physical phenomena.

### SUMMARY OF THE INVENTION

An instrument display is disclosed that provides increased utility and flexibility by employing multiple range visual depictions. An instrument according to the present teachings includes an instrument display for providing a visual depiction of a set of physical phenomena wherein the visual depiction includes a trace for each physical phenomenon superimposed on a set of axes that provide multiple ranges.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 illustrates an instrument according the present teachings;

FIGS. 2-4 show visual depictions rendered onto an instrument display according the present teachings.

### DETAILED DESCRIPTION

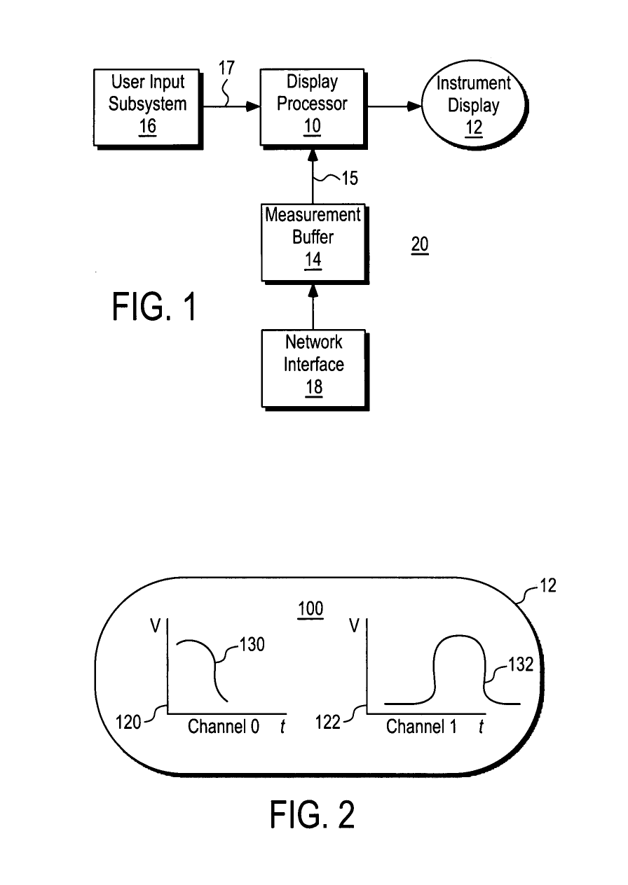

FIG. 1 illustrates an instrument 20 according the present teachings. The instrument 20 includes a display processor 10, an instrument display 12, and a user input subsystem 16. The display processor 10 obtains a set of measurements 15 that pertain a set of physical phenomena and renders a visual depiction for the physical phenomena onto the instrument display 12 using multiple ranges of a quantity of interest, e.g. time. In one embodiment, the display processor 10 generates a visual depiction on the instrument display 12 in response to a set of display parameters 17 specified by a user via the user input subsystem 16.

The measurements 15 may include measurements generated locally in the instrument 20, e.g. by one or more measurement channels (not shown) in the instrument 20. The measurements 15 may include measurements generated by a remote instrument (not shown). The instrument 20 includes a network interface 18 for receiving measurements generated by a remote instrument.

In one embodiment, the display processor 10 obtains the measurements 15 from a measurement buffer 14 in the instrument 20. Each measurement 15 in the measurement buffer 14 may include a time-value pair that specifies, respectively, a time at which a corresponding measurement was obtained and a value for the corresponding measurement. For example, in an embodiment in which the instrument 20 is an oscilloscope, a time-value pair may includes a time value, e.g. a real-time value, and a voltage value.

The measurement buffer 14 may hold measurement data for multiple variables, e.g. multiple measurement channels of the instrument 20 and measurement channels of remote instruments. For example, each time-value pair in the measurement buffer 14 may include a channel identifier. A channel identifier may specify a measurement channel of the instrument 20 for the corresponding time-value pair or a channel of another instrument connected via the network interface 18.

In another embodiment, the display processor 10 obtains the measurements 15 from one or more measurement channels in the instrument 20 or from the network interface 18 without passing the measurements 15 through a buffer.

The user input subsystem 16 enables a user to enter the display parameters 17. The display parameters 17 specify a set of ranges (range_1, range_2, . . . range_n) for a visual depiction to be generated on the instrument display 12. A specified range may include a starting time and a resolution. A starting time may be a real-time value. A resolution may be specified in terms of seconds per division of an axis drawn on the instrument display 12.

In addition, the display parameters 17 specify a mapping of local and remote measurement channels to the ranges and a visual arrangement of ranges. A mapping may be specified using channel identifiers that include a combination of an instrument identifier and a channel number.

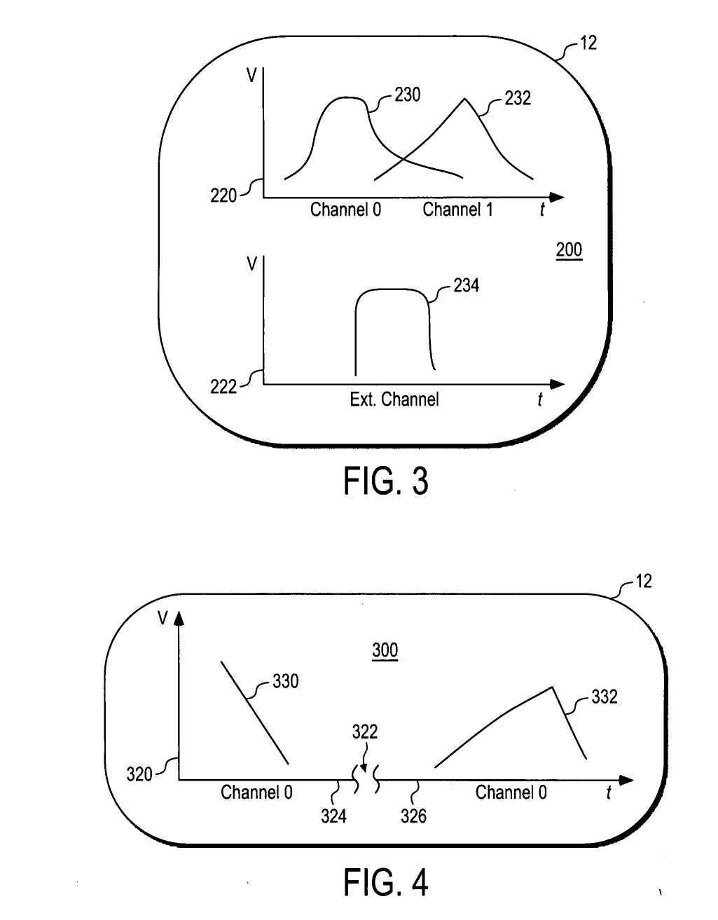

FIG. 2 shows a visual depiction 100 rendered onto the instrument display 12 according the present teachings. The visual depiction 100 includes a pair of traces 130 and 132 superimposed on a pair of respective axis 120 and 122. Each axis 120 and 122 includes an x component and a y component. The x component of each axis 120 and 122 represents time (t) and the y component of each axis 120 and 122 represents voltage magnitude (V).

The display parameters 17 for the visual depiction 100 may be as follows.

range_1=start-time_A, resolution_A,

instrument_A:channel_0;

range_2=start-time_B, resolution_B,

instrument_A:channel_1.

The display processor 10 draws the range_1 as the axis 120 and the range_2 as the axis 122. The display parameters 17 include a parameter that specifies a relative placement of the ranges, e.g. side by side as shown. The display processor 10 draws the trace 130 onto the axis 120 by obtaining measurement data for instrument_A:channel_0 from the measurement buffer 14. In this example, the parameter “instrument_A” identifies the instrument 20. The display processor 10 draws the trace 132 onto the axis 122 by obtaining measurement data for instrument_A:channel_1 from the measurement buffer 14. The display processor 10 draws a trace by drawing points onto the appropriate axis in response to the time-value pairs and then drawing connections among the points.

The start-time_A and resolution_A and start-time_B and resolution_B parameters provide a time scale for range_1 and a time scale for range_2, respectively. For example, start-time_A and start-time_B may be real-time values and resolution_A may be 1 millisecond per division and resolution_B may be 1 microsecond per division. The trace 130 may precede the trace 132 in time, may follow the trace 132 in time, or may overlap in time with the trace 132.

FIG. 3 shows a visual depiction 200 rendered onto the instrument display 12 according the present teachings. The visual depiction 200 includes a pair of traces 230 and 232 superimposed on an axis 220 and a trace 234 superimposed on an axis 222. The display parameters 17 for the visual depiction 200 may be as follows.

range_1=start-time_C, resolution_C,

instrument_A:channel_0;

range_1=start-time_C, resolution_C,

instrument_A:channel_1;

range_2=start-time_D, resolution_D,

instrument_B:channel_0.

The display processor 10 draws the range_1 as the axis 220 and the range_2 as the axis 222. The display parameters 17 may include a parameter that specifies a relative placement of the ranges, e.g. top to bottom as shown. The display processor 10 draws the traces 230 and 232 onto the axis 220 by obtaining measurement data for instrument_A:channel_0 and instrument_A:channel_1 from the measurement buffer 14. The display processor 10 draws the trace 234 onto the axis 222 by obtaining measurement data for instrument_B:channel_0 from the measurement buffer 14 or directly via the network interface 18.

The axes 220 and 222 may have different resolutions. The axes 220 and 222 may have the same or different start times. The trace 234 may precede the traces 230 and 232 in time, may follow the traces 230 and 232 in time, or may overlap in time with the traces 230 and 232.

FIG. 4 shows a visual depiction 300 rendered onto the instrument display 12 according the present teachings. The visual depiction 300 includes a pair of traces 330 and 332 superimposed on an axis 320. The x component of the axis 320 has a discontinuity 322 in time between a section 324 and a section 326. The display parameters 17 for the visual depiction 100 may be as follows.

range_1=start-time_E, resolution_E,

instrument_A:channel_0;

range_1=start-time_F, resolution_F,

instrument_A:channel_0.

The parameters start-time_E and resolution_E specify a time scale for the section 324 and the parameters start-time_F and resolution_F specify a time scale for the section 326. The display processor 10 draws the range_1 as the axis 320 including the sections 324 and 326 having the specified starting times and resolutions. The display processor 10 draws the traces 330 and 332 onto the axis 320 by obtaining measurement data for instrument_A:channel_0 from the measurement buffer 14. The display processor 10 uses the time values of the time-value pairs obtained from the measurement buffer 14 to map the measurement data points to the appropriate section 324 and 326. The sections 324 and 326 may have the same or different time resolutions. The visual depiction 300 may be particularly applicable in applications in which the time span between the start-time_E and the start-time_F is relatively large but the data of interest in the traces 330 or 332 is relatively brief. The view of the traces 330 and 332 may be expanded using appropriate selections for the resolution_E and the resolution_F.

The instrument 20 may include multiple displays for providing visual depictions according to the present techniques. The instrument 20 may export visual depictions to an external device via the network interface 18. For example, the instrument 20 may export visual depictions to another instrument or to a personal computer.

A visual depiction according to the present techniques may be partitioned vertically or horizontally. For example, a visual depiction may include a 2 by 2 array of axes or any other arrangement. In another example, one wide range axis may be stacked over two or more narrower range axes, or vice versa.

The traces in a visual depiction according to the present teachings may be triggered by an input signal sampled locally by the instrument 20 or may be triggered by a message received via the network interface 18 or may be triggered by a local real-time clock in the instrument 20. A trigger may be in the present or in the future. For example, if an experiment is to start at a known time then the traces may be triggered at that known time whether or not any signal of interest have occurred. Similarly, a trigger may be in the past and the traces drawn after the fact given that the measurements 15 are associated with time-stamps. Triggering on an event detected by a remote instrument using a network message may be applicable in systems in which the remote instrument is the only instrument capable of detecting the event. Triggering on a real-time (time-of-day) may be used to start traces even if the instrument 20 is not connected to a triggering event. This may be useful when it is desirable to show measurement values in relation to trigger time. Triggering in the past may be useful for showing measurements obtained by remote instruments or simulated measurements or measurements stored in a database as a function of real-time even when the measurements are not available in real-time.

The time axes in a visual depiction according to the present techniques are labeled so that an operator of the instrument 20 may know the time ranges for the various traces. For example, the starting times for a discontinuity are labeled. The time axes may be labeled with an absolute time when appropriate to an application.

A visual depiction according to the present techniques enables comparison of measurements obtained by multiple instruments. For example, traces from measurements generated by different instruments may be placed side-by-side and compared using a “marker” functions, e.g. a marker function of an oscilloscope. Marker A may be placed on an interesting point on a first trace and marker B placed on an interesting point of a second trace so that the instrument 20 shows the time in between.

A visual depiction according to the present techniques enables built in functions of the instrument 20 to be applied to measurements obtained by other instruments. For example, an RMS or rise-time measurement function of the instrument 20 may be applied to a trace that represents measurements received from a remote instrument.

A visual depiction according to the present techniques enables a view of one trace having a relatively large range next to a view of one or more other traces having relatively short but expanded ranges, i.e. traces that zoom-in in terms of time. This provides an operator of the instrument 20 with a view of intervals between events as well as a detailed view of events themselves.

The instrument 20 may include a marker function that provides a pair of markers for each trace. This allows an operator to explore a variety of relationships among traces without cluttering the instrument display 12. This may be particularly useful for a visual depiction having two ranges with that cover the same time span. For example, if events A, B, C, and D occur in sequence then two markers may be used on one range for A-C and two markers on another range for B-D.

The above embodiments show visual depictions having multiple ranges of time. Visual depictions according to the present techniques may be used to provides multiple ranges of any quantity. For example, the instrument 20 may be embodied as a spectrum analyzer that generates a visual depiction having multiple frequency-ranges. In another example, the instrument 20 may be embodied as a surface-roughness gauge which shows distance from the edge on the x-axis and the height of the surface on the y-axis.

In some embodiments, a range may be specified in terms of a starting time and an ending time or a starting time and a duration. In addition, the display parameters 17 may specify an allocation of axes to the viewable area of the instrument display 12. For example, the display parameters 17 may indicate that range_1 gets 75 percent of the display area and range_2 gets 25 percent of the display area.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. An instrument having an instrument display for providing a visual depiction of a set of physical phenomena wherein the visual depiction includes a trace for each physical phenomenon superimposed on a set of axes that provide multiple ranges.

2. The instrument of claim 1, wherein the axes include a first axis and a second axis rendered side by side on the instrument display.

3. The instrument of claim 2, wherein the axes include a third axis rendered above the first and second axes.

4. The instrument of claim 2, wherein the axes include a third axis rendered below the first and second axes.

5. The instrument of claim 1, wherein the axes include a first axis and a second axis rendered top to bottom on the instrument display.

6. The instrument of claim 1, wherein the axes include an axis with a discontinuity.

7. The instrument of claim 1, comprising a display processor that draws the traces in response to a set of measurements that pertain the physical phenomena.

8. The instrument of claim 7, wherein the measurements include a set of measurements generated by the instrument.

9. The instrument of claim 7, wherein the measurements include a set of measurements generated by a remote instrument.

10. The instrument of claim 7, wherein each measurement is associated with a time-stamp.

11. A method for providing a visual depiction of a set of physical phenomena on an instrument display comprising generating a trace on the instrument display for each physical phenomenon superimposed on a set of axes that provide multiple ranges.

12. The method of claim 11, wherein generating a trace comprises generating a first axis and a second axis side by side on the instrument display.

13. The method of claim 12, wherein generating a trace further comprises generating a third axis above the first and second axes.

14. The method of claim 12, wherein generating a trace further comprises generating a third axis below the first and second axes.

15. The method of claim 11, wherein generating a trace comprises generating a first axis and a second axis top to bottom on the instrument display.

16. The method of claim 11, wherein generating a trace comprises generating an axis with a discontinuity.

17. The method of claim 11, wherein generating a trace comprises generating the traces in response to a set of measurements that pertain the physical phenomena.

18. The method of claim 17, wherein the measurements include a set of measurements generated locally.

19. The method of claim 17, wherein the measurements include a set of measurements generated by remotely.

20. The method of claim 17, further comprising associating each measurement with a time-stamp.
